(19) United States
(12) Patent Application Publication
(10) Pub. No.: US 2009/0112685 A1
(43) Pub. Date: Apr. 30, 2009

(54) USER GENERATED ADVERTISING

(75) Inventors: Tomasz J. Tunguz-Zawislak, San Francisco, CA (US); Rob Kniaz, San Francisco, CA (US); Max Ventilla, San Francisco, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 11/925,250

(22) Filed: Oct. 26, 2007

(51) Int. Cl. G06Q 30/00; G06F 17/40; G06F 19/00

(52) U.S. Cl. 705/10; 705/14

(57) ABSTRACT

Methods, systems, and apparatus, including computer program products, in which an selections can be received, the selections including a content item (or items) and a creative item (or items) from a user. The advertisement creation engine can use the content item(s) and the creative item(s) to generate an advertisement. The advertisement can be distributed to a community (e.g., other users).

### TECHNICAL FIELD

The subject matter of this application is generally related to advertising.

### BACKGROUND

Interactive media (e.g., the Internet) has great potential for improving the targeting of advertisements (“ads”) to receptive audiences. For example, some websites provide information search functionality that is based on keywords entered by the user seeking information. This user query can be an indicator of the type of information of interest to the user. By comparing the user query to a list of keywords specified by an advertiser, it is possible to provide targeted ads to the user. An example of such a system is AdWords™ offered by Google, Inc. (Mountain View, Calif.).

Another form of online advertising is ad syndication, which allows advertisers to extend their marketing reach by distributing ads to additional partners. For example, third party online publishers can place an advertiser's text or image ads on web properties with desirable content to drive online customers to the advertiser's website. An example of such a system is AdSense™ offered by Google, Inc.

In some online advertising systems, advertisers pay for their ads on a Cost-Per-Click (CPC) basis. A common way for advertisers to set a CPC is to take a target Cost-Per-Action (CPA) and multiple it by an average Click-Through-Rate (CTR) on a keyword. CPA is an online advertising Return-On-Investment (ROI) metric in which return is based solely on qualifying actions, such as a sale or registration, as measured against the marketing costs associated with reaching that sale or registration.

Advertisers, however, have occasionally failed to capitalize on opportunities provided by the internet. For example, “viral” marketing efforts attempt to create internet “buzz” surrounding a product. The “viral” aspect of a campaign typically refers to the attempt to make a marketing campaign “infectious” by causing consumers to talk about the ad or product. However, such efforts can be recognized as artificial and may fail to focus on a particular market segment that may be interested in the product.

### SUMMARY

This specification describes technologies related to advertising systems. In some implementations, a system can include an advertisement creation engine and a distribution engine, among others. The advertisement creation engine can be used to provide an advertisement creation environment. The advertisement creation environment can enable selection of one or more content items and one or more creative items. The advertisement creation engine can receive instructions associated with the content items and creative items and can generate an advertisement based on the instructions. The distribution engine can store created advertisement and serve the advertisement to a community

Methods of generating advertisements can include, for example: receiving a first selection for a content item from a user; receiving a second selection for a creative item from the user; identifying a user-defined advertisement based upon the first and second selections; and, distributing the user-defined advertisement based on the identification.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an implementation of an online advertising system 100.

FIG. 2 is a flow chart of an example of a process 200 for creating an advertisement.

FIG. 3 is a flow chart of an example of a process 200 for publishing an advertisement.

FIG. 4 is a flow chart of an example of a process 400 for preparing an advertisement for publishing.

FIG. 5A is a flow chart of an example of a process 500 for real-time reporting of conversions from advertisements to actions.

FIG. 5B is a flow chart of an example of a process 500 for non real-time reporting of conversions from advertisements to actions.

FIG. 6 is a flow chart of an example of a process 600 for charging advertisers and crediting publishers for conversions from advertisements to actions.

FIG. 7 is a first portion of an example of a user interface 700 for selecting a referral item.

FIG. 8 is a second portion of an example of a user interface 800 for selecting a referral item.

FIG. 9 is an example of a user interface 900 for selecting referral units associated with a referral item.

FIG. 10 is an example of a user interface 1000 for presenting code snippets, associated with referral units, to be presented by a publisher system.

FIG. 11 is an example of a user interface 1100 for creating a referral unit.

FIG. 12 is an example of a user interface 1200 for presenting a code snippet, associated with a referral unit, to be used at an advertiser system.

FIG. 13 is an example of a user interface 1300 for presenting a conversion action report to an advertiser user.

FIG. 14 is a block diagram of an example of a system for storing and retrieving conversion values.

FIG. 15 is a block diagram of example architecture 1500 for an advertising system manager/payment system.

### DETAILED DESCRIPTION

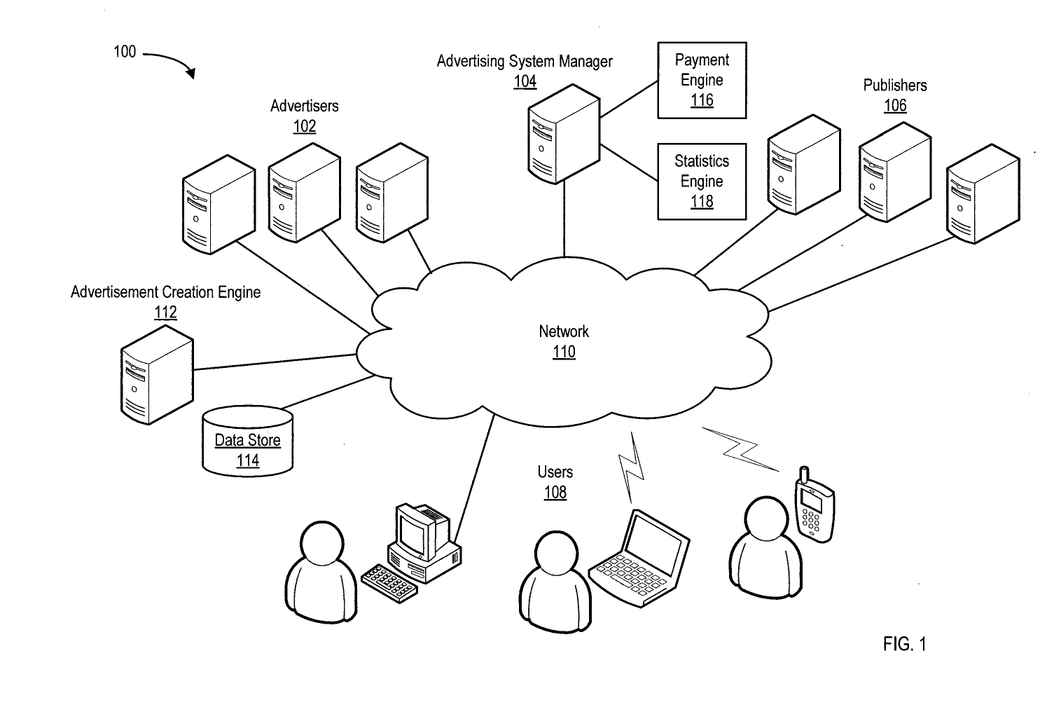

FIG. 1 is a block diagram of an implementation of an online advertising system 100. In some implementations, one or more advertisers 102 can directly, or indirectly, enter, maintain, and track advertisement (“ad”) information in an advertising management system 104. The ads may be in the form of graphical ads, such as banner ads, text only ads, image ads, audio ads, video ads, ads combining one of more of any of such components, etc. The ads may also include embedded information, such as a links, meta-information, and/or machine executable instructions. The advertising system 100 can deliver other forms of content (i.e., content other than ads). One or more publishers 106 may submit requests for ads to the system 104. The system 104 responds by sending ads to the requesting publisher 106 (or to a browser rendering a page request associated with the publisher) for placement on one or more of the publisher's web properties (e.g., websites and other network-distributed content). The ads can be placed with or embedded in the publisher's content (e.g., videos, articles, search results), which can be stored in repositories associated with the publishers 102, and/or placed with content received from other sources (e.g., other publishers, advertisers). Alternatively, the ads may be served along with search results, or in other operational configurations.

Other entities, such as users 108 and the advertisers 102, can provide usage information to the system 104, such as, for example, whether or not a conversion or click-through related to an ad has occurred. This usage information can include measured or observed user behavior related to ads that have been served. The system 104 performs financial transactions, such as crediting the publishers 106 and charging the advertisers 102 based on the usage information.

A computer network 110, such as a local area network (LAN), wide area network (WAN), the Internet, or a combination thereof, connects the advertisers 102, the system 104, the publishers 106, and the users 108.

In some implementations, the online advertising system 100 can include an advertisement creation engine 112. The advertisement creation engine 112 can provide an advertisement creation interface. The advertisement creation interface can enable users 108 to create advertisements based upon combining content items (e.g., pictures, videos, or other content) with creative items (brands, logos, trade names, trademarks, service marks, product representations, etc.), which can be supplied, for example, by the advertisers 102.

In various implementations, the advertisement creation interface can be, for example, an agent embedded within a web page supplied to the user. The agent can be executed, for example, upon loading of the web page by a browser. In other implementations, the agent can be a toolbar or a standalone application executing on a user device 108. Other implementations of the advertisement creation interface are possible.

The creative items can be retrieved, for example, from a creative item repository (e.g., data store) associated with a particular advertiser 102. In other examples, advertisers 102 can upload the creative items to the advertisement creation engine 112 and the creative items can be stored in a creative item repository (e.g., data store 114), which can be associated with the advertisement creation engine 112. The creative items can include, for example, various trademarks, logos, trade names, service marks, models, makes, products, services, graphical product representations, among many others, which the advertisers 102 would like to publicize. In some implementations, users 108 can suggest creative items for approval by the advertiser and inclusion within a creative item.

The content items, in some implementations, can be retrieved from a content item repository (e.g., data store 114). The content item repository, in some implementations can be associated with either the advertisers 102 or the advertisement creation engine 112. In some implementations, such content items can include content (e.g., pictures, videos or other content) which has been dedicated to the public domain. In other implementations, the content items can include content which has been licensed from a third party for use in conjunction with advertisements. Licensed content, in some examples, can be segregated based upon which advertisers have licensed the content. In other examples, licensed content can be subject to a general license for use with the advertisement creation engine 112.

In another implementation, the content items can include content supplied (e.g., uploaded) by a user 108 to the advertisement creation engine 112. In some of these implementations, the advertisement creation engine 112 and/or advertising system manager 104 can include mechanisms to prevent unauthorized use of copyrighted content. Such mechanisms can include a reporting feature enabling copyright owners to report unauthorized use of copyrighted content. Other mechanisms for filtering unauthorized use of copyrighted content are possible.

The advertisement creation engine 112 can enable a user 108 to create an advertisement by combining content items and creative items. In one implementation, the advertisement creation engine 112 can operate to determine a ratio between content items and creative items selected for inclusion in the advertisement by the user 108. In one implementation, the advertisement creation engine 112 can require a specified ratio between content items and creative items comprising an advertisement based upon, for example, instructions received from an advertiser 102. The advertisement creation engine 112 can communicate the user created advertisement to, for example, the advertising system manager 104 for publication. In some implementations, the system can include a distribution engine (e.g., advertising system manager 104) operable to distribute (e.g., syndicate) advertisements submitted by users to one or more publishers 106. The distribution engine can be implemented, for example, by an advertising system manager (e.g., advertising system manager 104 of FIG. 1).

In one implementations, the user 108 can be a publisher 106. For example, the user can create a website on a platform such as MySpace, available from News Corporation of New York, N.Y., and include a user generated advertisement. In other implementations, the user can post their advertisement to a publisher 106 site. The publisher 106 site can include, for example, sites such as YouTube, available from YouTube, Inc. of San Bruno, Calif. In some implementations, the publisher 106 of the site can make the advertisement available for syndication or another form of distribution (e.g., publication) to other publishers 106 or users 108. For example, a publisher 106 of a site can enable a user 108 to distribute the advertisement to other users 108. In other implementations, the advertiser 102 can make the advertisement available for syndication to multiple publishers 106 using, for example, the advertising system manager 104.

In some implementations, advertisers 102 can approve or disapprove of advertisements prior to distribution (e.g., publication, syndication, etc.). In such implementations, the advertising system manager 104 can store advertisements (e.g., referral units) with a marker (e.g., a flag) indicating that the advertisement has not been approved for distribution to publishers. In alternative implementations, the advertisements can be sent directly to the advertisers for approval. Such implementations can enable advertisers to hinder attempts by unfriendly users (e.g., competitors, hackers, or other malicious users) to create unflattering (e.g., parody, insulting, satirical, etc.) advertisements associated with the advertiser's brand. Other mechanisms to filter unflattering advertisements are possible.

In one implementation, syndication of an advertisement can enable a portion of the cost paid by the advertisers 102 upon conversion, for example, to be directed to a user 108 associated with the creation of the advertisement. In other implementations, the advertisers 102 can offer terms which can be assented to, for example, by the creation of advertisements by users 108. Terms of the agreement, in various implementations, can include definition of what action comprises a conversion (e.g., sale, entry to the advertiser website, selection of the advertisement, etc.), the amount of payment for a conversion, terms of use, and other contractual stipulations.

Payment for conversions associated with user created advertisements can utilize, for example, a revenue share between the publisher 106 and the user 108 responsible for creation of the advertisement, or a direct payment from the advertiser 102 to the user 108 responsible for the creation of the advertisement, among others. In some implementations, users 108 maintain an account (e.g., an online account) which can be accessed by the advertising system manager 104 or an account adjustment engine (e.g., payment engine 116). In another implementation, the advertiser 102 can deploy a rewards system, whereby users 108 creating advertisements can obtain credits based on conversions associated with those advertisements. The users, for example, can redeem those credits for value (e.g., merchandise, services, etc.) offered by the advertiser 102. Other payments systems are possible.

In some implementations, the advertising systems manager 104 can include a statistics engine 118. The statistics engine 118 can enable the advertising systems manager 104 to collect statistics related to the advertisement. Such statistics can include, for example, any conversions resulting from the advertisement. In other examples, the statistics can also include other statistics associated with the advertisements (e.g., click through rate, goal path adherence for customers associated with the user created advertisement, fraudulent conversion rates, etc.). Statistics from the statistics engine 118 can be used, for example, by the payment engine 116 to process adjustments to accounts associated with users 108, advertisers 102 and/or publishers 106, or any combination thereof.

One example of a publisher 106 is a general content server that receives requests for content (e.g., articles, discussion threads, music, video, graphics, search results, web page listings, information feeds, etc.), and retrieves the requested content in response to the request. The content server may submit a request for ads to an ad server in the system 104. The ad request may include a number of ads desired. The ad request may also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the ads provided by the system 104. This combined content and ads can be sent to the user 108 that requested the content for presentation in a viewer (e.g., a browser or other content display system). The content server can transmit information about the ads back to the ad server, including information describing how, when, and/or where the ads are to be rendered (e.g., in HTML or JavaScript™). Alternatively, the content and the ads can be combined in the user's viewer at a time of rendering.

Another example publisher 106 is a search service. A search service can receive queries for search results. In response, the search service can retrieve relevant search results from an index of documents (e.g., from an index of web pages). An exemplary search service is described in the article S. Brin and L. Page, “The Anatomy of a Large-Scale Hypertextual Search Engine,” Seventh International World Wide Web Conference, Brisbane, Australia and in U.S. Pat. No. 6,285,999, both of which are incorporated herein by reference each in their entirety. Search results can include, for example, lists of web page titles, snippets of text extracted from those web pages, and hypertext links to those web pages, and may be grouped into a predetermined number of (e.g., ten) search results.

The search service can submit a request for ads to the system 104. The request may include a number of ads desired. This number may depend on the search results, the amount of screen or page space occupied by the search results, the size and shape of the ads, etc. In some implementations, the number of desired ads will be from one to ten, or from three to five. The request for ads may also include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores), snippets of text extracted from identified documents (e.g., web pages), full text of identified documents, feature vectors of identified documents, etc. In some implementations, IR scores can be computed from, for example, dot products of feature vectors corresponding to a query and a document, page rank scores, and/or combinations of IR scores and page rank scores, etc.

The search service can combine the search results with one or more of the ads provided by the system 104. This combined information can then forwarded to the user 108 that requested the content. The search results can be maintained as distinct from the ads, so as not to confuse the user between paid advertisements and presumably neutral search results.

Finally, the search service can transmit information about the ad and when, where, and/or how the ad was to be rendered back to the system 104.

As can be appreciated from the foregoing, the advertising management system 104 can serve publishers 106, such as content servers and search services. The system 104 permits serving of ads targeted to documents served by content servers. For example, a network or inter-network may include an ad server serving targeted ads in response to requests from a search service with ad spots for sale. Suppose that the inter-network is the World Wide Web. The search service can crawl much or all of the content. Some of this content will include ad spots (also referred to as “inventory”) available. More specifically, one or more content servers may include one or more documents. Documents may include web pages, email, content, embedded information (e.g., embedded media), meta-information and machine executable instructions, and ad spots available. The ads inserted into ad spots in a document can vary each time the document is served or, alternatively, can have a static association with a given document.

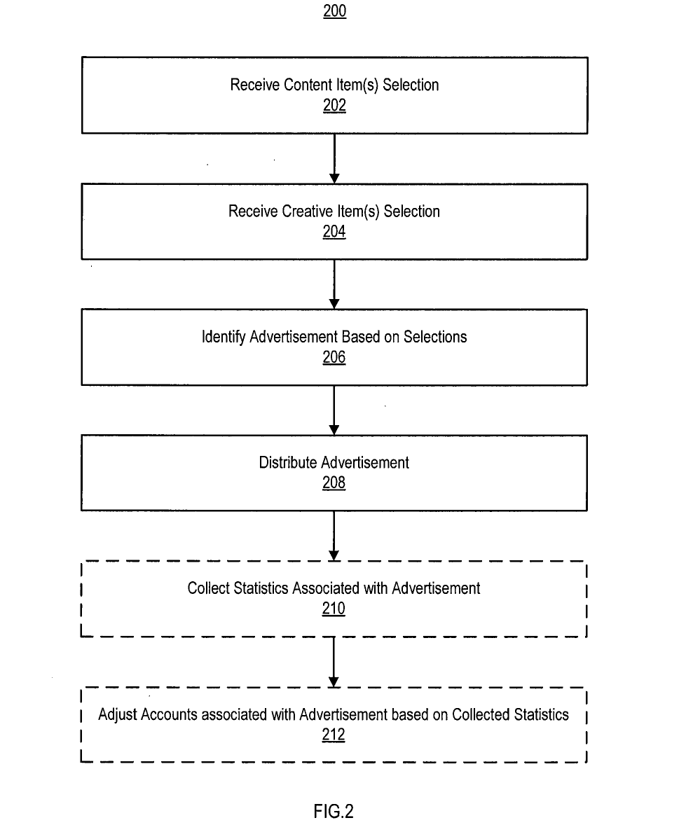

FIGS. 2, 3, 4A, 4B, and 5 are flow charts of example processes 200, 300, 400, 500, 508, and 600 that may be performed, for example, by a system such as the system 100 and, for clarity of presentation, the description that follows uses the system 100 as the basis of an example for describing the processes 200, 300, 400, 500, 508, and 600. However, another system, or combination of systems, may be used to perform the processes 200, 300, 400, 500, 508, and 600.

FIG. 2 is a flow chart of an example of a process 200 for creating an advertisement. Process 200 begins with a selection of content items (202). The selection of content items can be provided by, for example, an advertisement creation system (e.g., advertisement creation engine 112 of FIG. 1) using an advertisement creation interface. Content items can include content such as, for example, pictures, videos, games, puzzles, or other forms of content. The content items, in various implementations, can be supplied by the user, can be retrieved from a content item repository (e.g., a content item data store), or combinations thereof. In some implementations, content items supplied by the user can be subject to approval by the advertiser 102 prior to distribution (e.g., publication, syndication, etc.). Advertiser approval can be used, for example, to filter inappropriate content, unauthorized use of copyrighted content, or unflattering content, among others.

Process 200 receives selection of creative items (204). The selection of creative items can be provided by, for example, an advertisement creation system (e.g., advertisement creation engine of FIG. 1) using an advertisement creation interface. Creative items can include advertising items such as, for brand names, products, slogans, mottos, product representations (e.g., images of the product), logos, and any other source identifier associated with the advertiser 102 or advertiser product (e.g., trademarks, trade names, service marks, trade dress, etc.). The creative items, in various implementations, can be supplied by the user, or can be retrieved from a content item repository (e.g., a content item data store), or combinations thereof. In some implementations, creative items supplied by the user can be subject to approval by the advertiser 102 prior to making the creative items available to others, and/or prior to making the creative items available for other forms of distribution (e.g., publication, syndication, etc.). In such implementations, advertisers 102 can ensure that user defined creative items include advertising items promoting something associated with the company, while facilitating the filtering of other content (e.g., inappropriate content, unlicensed content (e.g., copyrighted content), unflattering content, etc).

Process 200 identifies an advertisement based on the selections (206). The identification of an advertisement can be provided by, for example, an advertisement creation system (e.g., advertisement creation engine 112 of FIG. 1). In other implementations, the identification of an advertisement can be provided by, for example, an advertising system manager (e.g., advertising system manager 104 of FIG. 1). The identification of an advertisement can include linking selected content items and creation items together in an order/arrangement specified by the user and storing the linked and/or ordered content items and creative items to a data store (e.g., a referral unit repository).

Process 200 distributes the advertisement based on the selections (208). The distribution of an advertisement can be provided by, for example, an advertisement creation system (e.g., advertisement creation engine 112 of FIG. 1). In other implementations, the distribution of an advertisement can be provided by, for example, a distribution engine associated with an advertising system manager (e.g., advertising system manager 104 of FIG. 1). The distribution of an advertisement can include publishing and/or syndicating the advertisement through the internet using various protocols (e.g., the world wide web).

Process 200 collects statistics associated with the advertisement (210). The statistics collection can be provided, for example, by a statistics collection engine associated with an advertising system manager (e.g., advertising system manager 104 of FIG. 1). Statistics associated with the advertisement can be collected as described below. In one implementation, the statistics can measure the conversions associated with the advertisement. In other implementations, the statistics can measure other statistics associated with the advertisement, such as, for example, conversion rate, fraudulent conversions, goal path adherence, etc.

Process 200 adjusts account(s) associated with the advertisement based on the collected statistics (210). The account adjustment can be provided, for example, by an account adjustment engine associated with an advertising system manager (e.g., advertising system manager 104 of FIG. 1). Accounts can be adjusted based on terms of an agreement agreed to by a user and an advertiser when the user chose to distribute the advertisement using an advertising system (e.g., advertising system 100 of FIG. 1). In some implementations, an account associated with an advertiser (e.g., advertiser 102 of FIG. 1) with whom the advertisement is associated can be debited to pay a publisher (e.g., publisher 106 of FIG. 1) associated with the distribution of the advertisement, and a user (e.g., user 108 of FIG. 1) associated with the creation of the advertisement. In other implementations, an account associated with a user (e.g., user 108 of FIG. 1), with whom a distributed advertisement is associated, is credited based upon a conversion associated with the advertisement. In further implementations, an account associated with a publisher (e.g., publisher 106 of FIG. 1) is credited based upon a conversion associated with the advertisement.

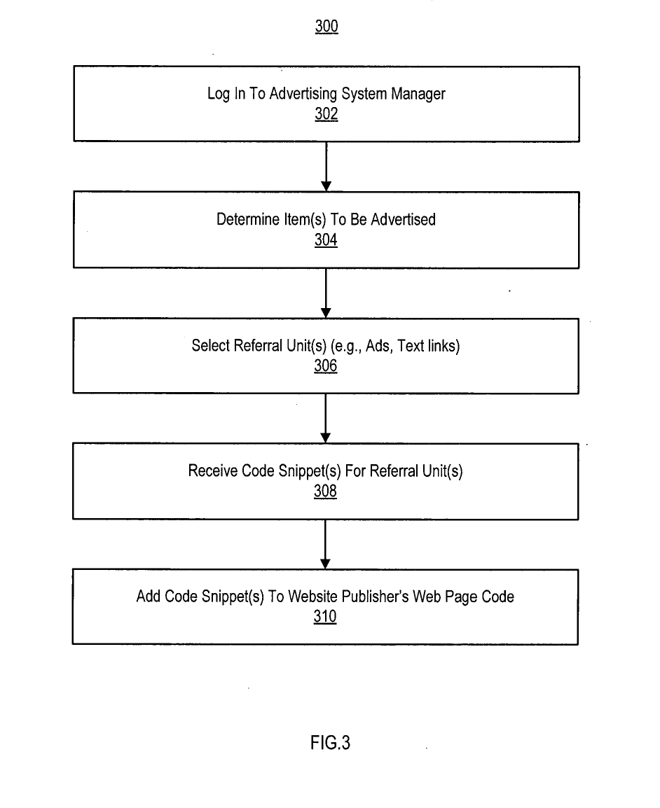

FIG. 3 is a flow chart of an example of a process 300 for publishing an advertisement. Process 300 begins with a login (302) to an advertising system manager. For example, a user at one of the publisher systems 106 may login to the advertising system manager/payment system 104 by providing a user name and password to the system 104. The login may occur, for example, via a web page and the login process may use encryption, such as secure Hypertext Transfer Protocol (HTTPS).

Process 300 determines (304) one or more items to be advertised. For example, the publisher user may select from a list specific products and/or services (referred to here as referral items) to advertise at a publisher site. The list of referral items may be the result of a search initiated by the publisher user based on, for example, a keyword or category selection made by the publisher user. In another example, the publisher user may select one or more keywords and/or one or more referral item categories that the system 104 may use to automatically determine referral items. Alternatively, the publisher 106 may provide site content to the system 104 or the system 104 may retrieve site content from the publisher 106. The system 104 then may contextually determine referral items based on, for example, relevance of referral items to the publisher site content. In another example, the system 104 may determine referral items based on behaviors of the end user, such as a particular search query performed on a search engine website, or a geographical location of the end user, such as products/services for businesses located near the end user. In addition, a combination of the examples for determining referral items described above may be used.

Process 300 selects (306) one or more referral units associated with the determined referral items. For example, the publisher user may select particular ads (e.g., referral units) associated with a determined referral item to present on a publisher web site. Ads may include, for example, text links, images, audio, video, or other media and may be formatted, for example, in a banner/horizontal orientation or a sidebar/vertical orientation. In this example, the publisher user selects the referral units to present at the publisher web site. Alternatively, the system 104 may select appropriate referral units based on, for example, a predetermined referral unit type specified by the publisher user, such as banner ads. In addition, the system 104 may rotate the selected referral unit from a list of referral units.

Process 300 receives (308) one or more code snippets, each associated with a selected referral unit. In one implementation, each code snippet includes a signed or encoded specification of the referral ad(s) determined by the publisher. For example, the publisher 106 may receive a code snippet, from the system 104, associated with a selected referral unit, such as a banner ad for an MP3 (MPEG-1 Audio Layer 3) music player. In some implementations, the code snippet includes a specification corresponding to the selected ad(s) that associates each of the selected ad(s) with a set of conversion actions (e.g., purchasing the MP3 player, subscription to a mailing list) which may result from an end user's interaction with the ad. In other implementations, when the ads that are eligible for a particular set of conversion actions are known by the system 104, the specification can be omitted from the code snippet. When a conversion occurs, the conversion action allows the system 104 to determine how much the publisher 106 is credited resulting from showing the ad at the publisher web site.

Process 300 adds (310) the one or more code snippets to a website publisher's web page code. For example, the publisher 106 may add the banner ad code snippet to the publisher web page. In some implementations, the code snippet is a web script, such as JavaScript. The execution of the code snippet by the end user 108 results in a contact with the system 104 and the display of the advertisement to the end user 108. In some implementations, when the end user 108 clicks on the displayed advertisement, the system 104 is contacted again, and the end user 108 is redirected to the advertiser's site. During this event the end user 108 receives a signed browser cookie from the system 104. Tampering with the contents of the signed cookie can invalidate conversion actions associated with the cookie. The cookie includes information, such as an identifier of the MP3 player banner ad, an identifier of the publisher 106, and the date/time the banner ad was selected by the user 108. The cookie is then used together with information associated with conversion actions performed at the advertiser 102 by the end user 108 to credit the publisher 106 and debit the advertiser 102.

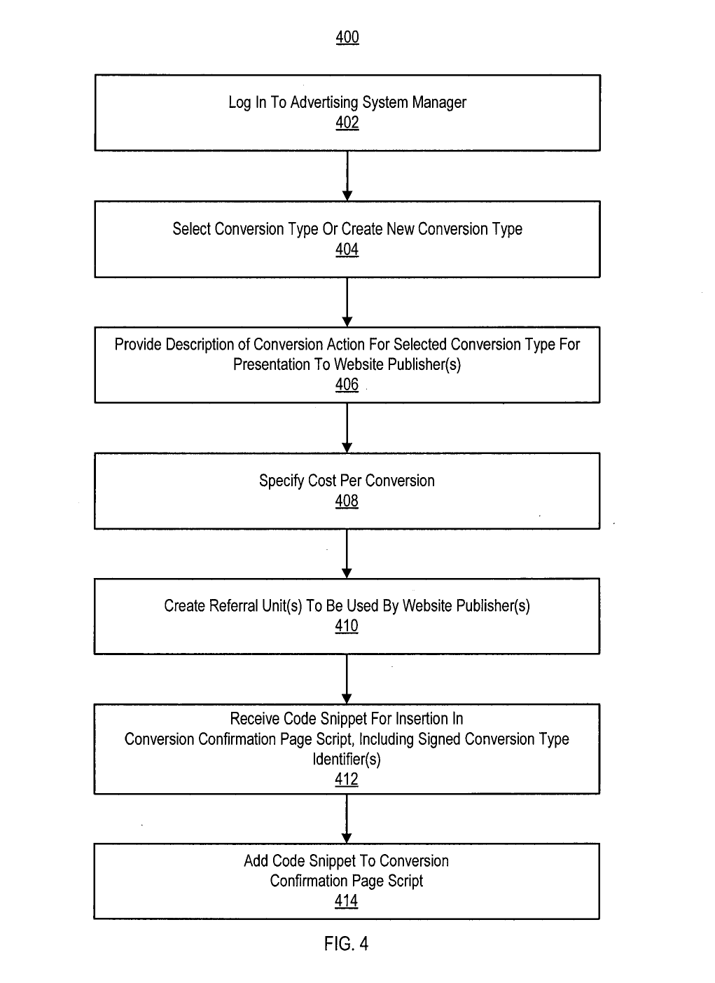

FIG. 4 is a flow chart of an example of a process 400 for preparing an advertisement for publishing. Process 400 begins with a login (402) to an advertising system manager. For example, a user at one of the advertiser systems 106 may login to the advertising system manager/payment system 104 by providing a user name and password to the system 104. The login may occur, for example, via a web page and the login process may use encryption, such as secure Hypertext Transfer Protocol (HTTPS).

Process 400 selects (404) a conversion type or creates a new conversion type. For example, a user of the advertiser system 102 may select a conversion type from a list provided by the system 104 or make an input including a new conversion type. Each conversion type corresponds to a conversion action that the end user 108 may perform, such as a purchase of a product or service, a selection of a banner ad (click-through) or other action.

Process 400 provides (406) a description of the conversion action for the selected conversion type for presentation to website publishers. For example, the advertiser 102 may input description information to the system 104 to assist the publishers 106 in determining referral units to publish.

Process 400 specifies (408) a cost per conversion. For example, the advertiser 102 may input a cost/value associated with the selected conversion type, such as a 5 dollar credit to the publisher 106 for each product or service purchased.

Process 400 creates (410) referral units to be used by website publishers. For example, the advertiser 102 may create a banner ad that the publisher 106 provides the end user 108.

Process 400 receives (412) a code snippet. In one implementation, the code snippet includes one or more signed conversion type identifiers (IDs), for insertion in a confirmation page script. For example, the system 104 can generate a signed conversion type identifier associated with the selected conversion type, the specified cost per conversion, and the created referral unit. The system 104 transmits the signed conversion type identifier to the advertiser 102 within a code snippet.

Process 400 adds (414) the code snippet to a conversion confirmation page script. For example, the end user 108 selects a particular banner ad at the publisher 106. The publisher code snippet directs the end user 108 to the system 104 from which a signed browser cookie is retrieved. The end user 108 is then directed to a web page at the advertiser 102. The end user 108 performs a conversion action at the advertiser 102, such as purchasing a product or service. The advertiser code snippet is included within a conversion confirmation page script, such as a script within a web page presented after the purchase. The end user 108 executes the advertiser code snippet. The advertiser code snippet contacts the system 104 and reports the conversion type identifier from the advertiser code snippet as well as information from the cookie, such as a publisher identifier, a referral unit identifier, and a date/time of the referral unit impression and click.

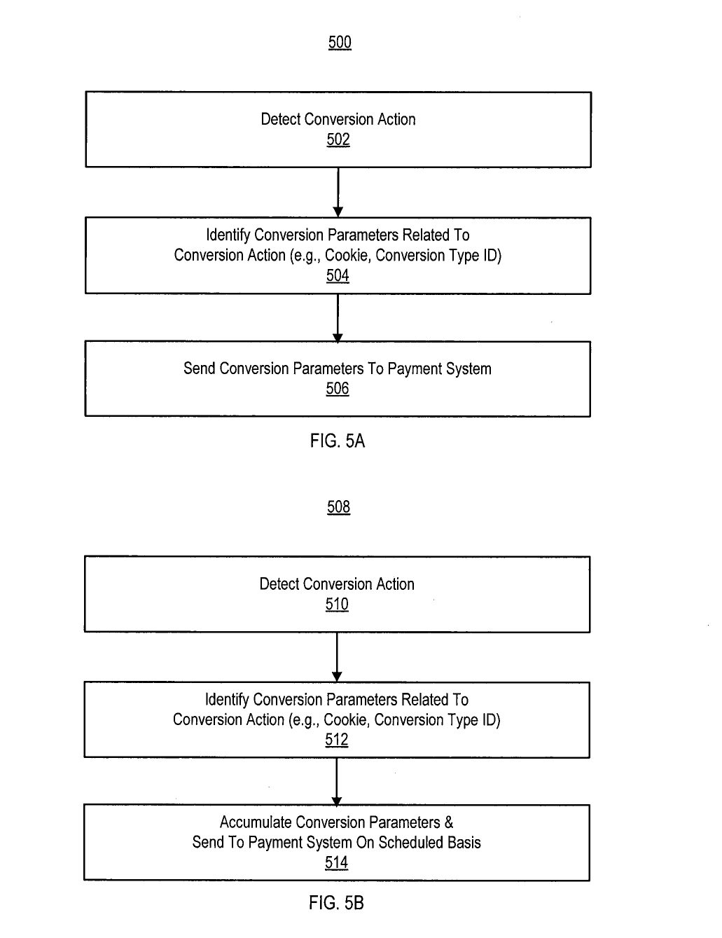

FIG. 5A is a flow chart of an example of a process 500 for real time reporting of conversions from advertisements to actions. Process 500 begins with detecting (502) a conversion action. For example, the advertiser code snippet may be executed from a conversion confirmation web page indicating that the end user 108 performed a conversion action.

Process 500 identifies (504) conversion parameters related to the conversion action (e.g., information from a cookie or a conversion type identifier). For example, the advertiser code snippet may retrieve a referral unit identifier, a publisher identifier, and a date/time of the referral unit impression and click from a cookie located at the end user 108. The advertiser code snippet includes the conversion type identifier associated with the conversion action performed by the end user 108.

Process 500 sends (506) conversion parameters to a payment system. For example, the advertiser code snippet, executing at the end user 108, transmits the identified conversion parameters to the system 104.

FIG. 5B is a flow chart of an example of a process 508 for reporting accumulated conversions from advertisements to actions. Process 508 begins with detecting (510) a conversion action. For example, the advertiser code snippet may be executed from a conversion confirmation web page indicating that the end user 108 performed a conversion action.

Process 508 identifies (512) conversion parameters related to the conversion action (e.g., information from a cookie or a conversion type identifier). For example, the advertiser code snippet may retrieve a referral unit identifier, a publisher identifier, and a date/time of the referral unit impression and click from a cookie located at the end user 108. The advertiser code snippet includes the conversion type identifier associated with the conversion action performed by the end user 108.

Process 508 accumulates (514) conversion parameters and sends the conversion parameters to a payment system on, for example, a scheduled basis. For example, the advertiser code snippet, executing at the end user 108, transmits the identified conversion parameters to the advertiser 102. The advertiser 102 accumulates the conversion parameters and transmits them (e.g., periodically) to the system 104.

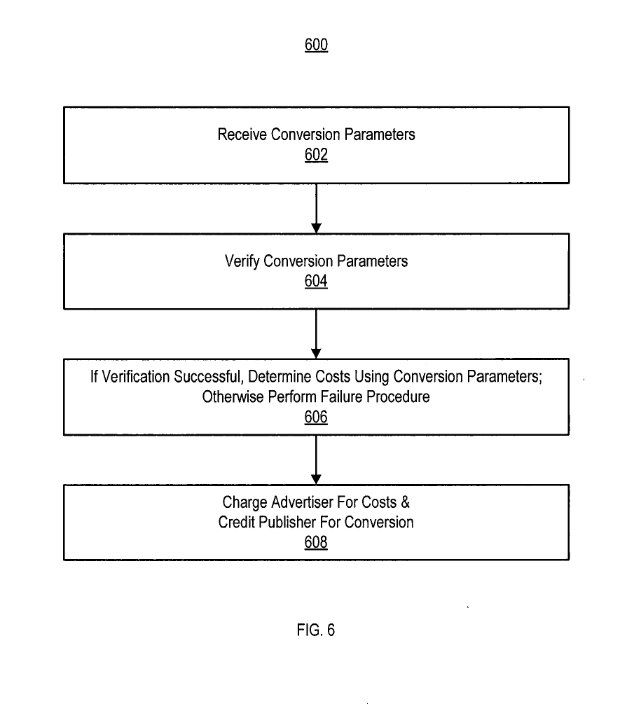

FIG. 6 is a flow chart of an example of a process 600 for charging advertisers and crediting publishers for conversions from advertisements to actions. Process 600 begins with receiving (602) conversion parameters. For example, the payment system 104 may receive a purchase conversion type identifier, a banner ad identifier, the publisher identifier, and the date/time of the banner ad selection.

Process 600 verifies (604) the received conversion parameters. For example, the system 104 verifies the signatures from the cookie information and the conversion type identifier. Modifying the cookie information or the conversion type identifier invalidates their signatures and correspondingly the associated conversion action.

If the verification is successful, process 600 determines (606) costs using the conversion parameters, otherwise the process 600 performs a failure procedure. For example, the system 104 may retrieve a conversion cost/value associated with the conversion type identifier in the conversion parameters. In addition, repeated conversion actions by an end user may be tracked in the cookie information. Repeated conversion actions may be credited/debited in a different manner than an initial conversion action, such as at a reduced rate or not at all. Failed conversion actions may be tracked and reported to the advertiser 102. In some implementations, the system 104 is tamper proof because no parameters can be altered or fabricated by users, publishers or advertisers.

Process 600 charges (608) the advertiser for costs and credits the publisher for conversion. For example, the system 104 may charge the advertiser 102 and credit the publisher 106 for a purchase conversion. Sophisticated replaying of the same conversion action using the same cookie can be caught by a statistical filtering process at the system 104 based on signals generated from all aspects of the advertising process, as detailed later.

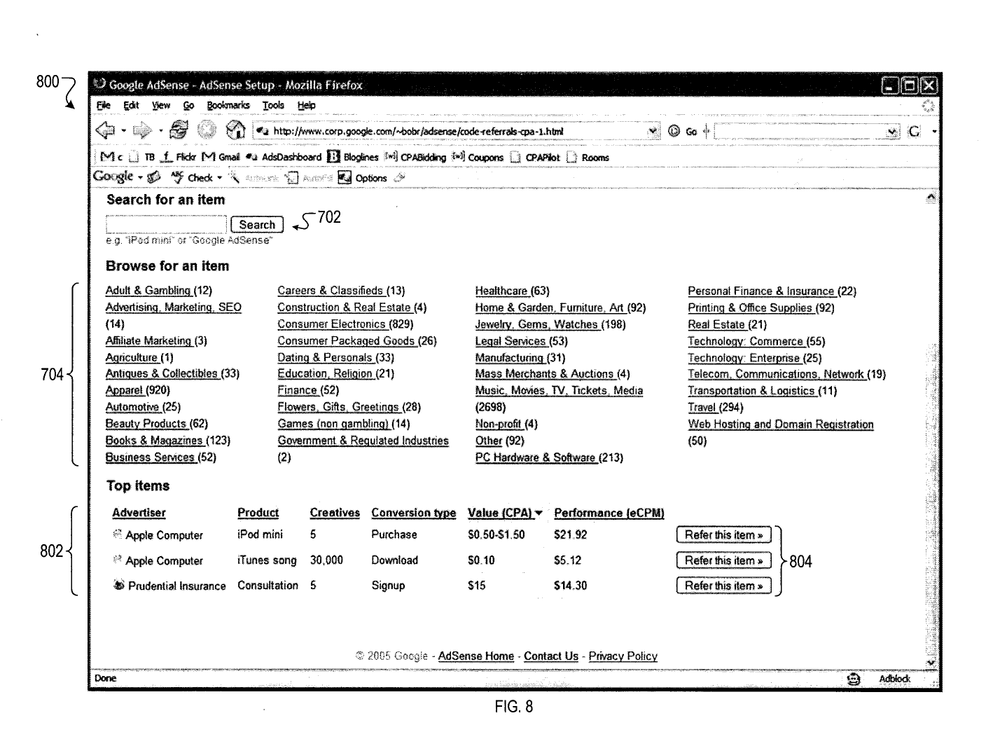

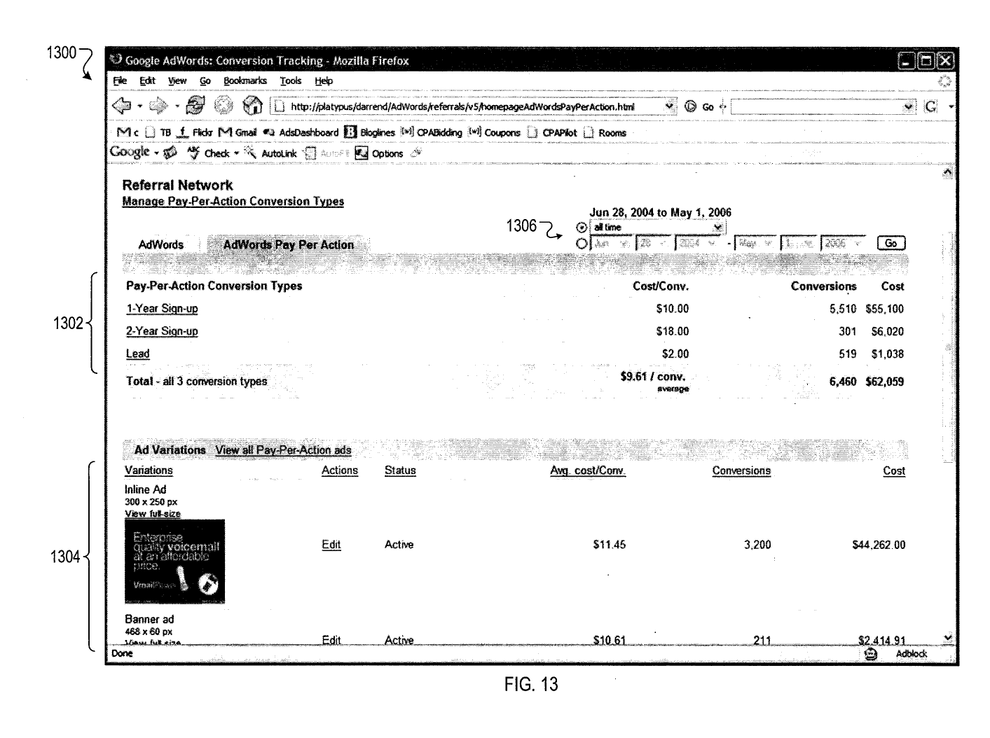

In some implementations, data associated with conversion actions can be aggregated and analyzed to generate performance data for the entire advertising system 100, which can then be shared with publishers and advertisers. For example, conversion rates and other metrics or statistics can be calculated and presented to publishers and advertisers in the user interfaces described in reference to FIGS. 8 and 13. Such information can be used in ad space auctions or to improve the confidence of performance predictions for ads.

In some implementations, the system keeps track of information on all aspects of the advertising process including but not limited to: serving the ad, clicking the ad, and conversions resulting from the ad clicks. This information (which can be tracked using cookies) can be used to create signals (e.g., click throughput rates, click delay, the IP address from which the action originates) for detecting misbehaviors by users or publishers. For example, the system can detect repeated conversion events (e.g., spammed conversions) based on the uniqueness of an ad's impression. Based on information collected, the system can correlate repeated conversion events and sequentially filter out spammed conversions and take actions on the offenders (e.g., terminate accounts, issue warnings).

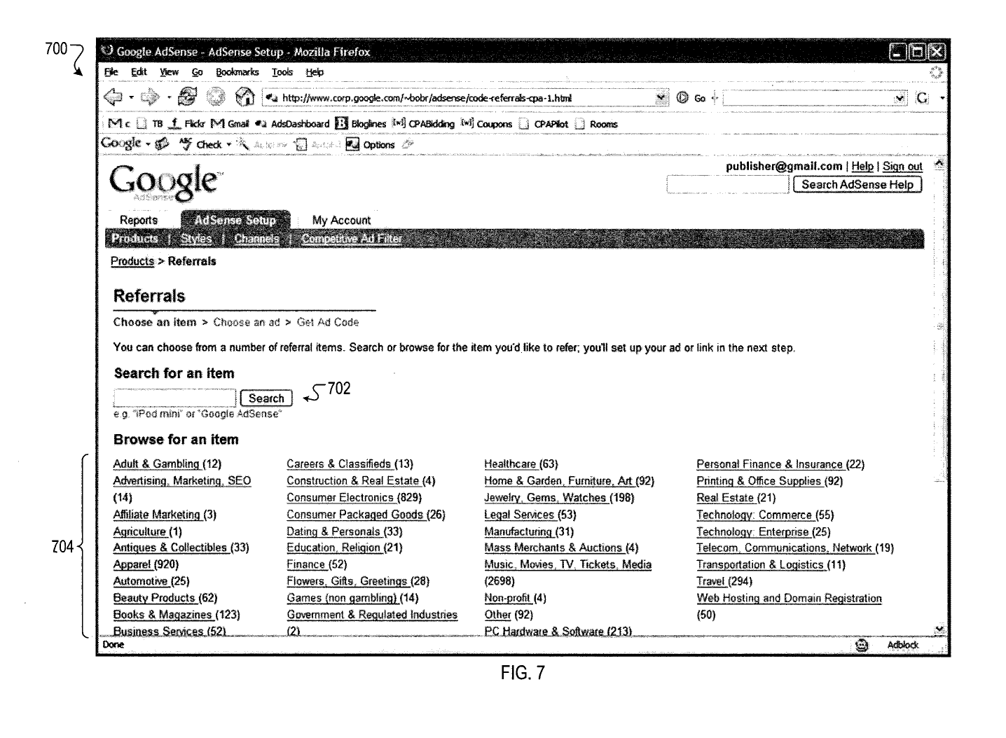

FIG. 7 is a first portion of an example of a user interface 700 for selecting a referral item. The interface 700 includes a search control 702. The search control 702 allows a publisher user to input a search keyword to identify referral items for possible publication at the publisher 106. Alternatively, the publisher user may select a referral item category from a referral item category list 704. Each category indicates a number of included referral items. Selecting a referral item category may present a list of the included referral items.

FIG. 8 is a second portion of an example of a user interface 800 for selecting a referral item. The interface 800 includes a list of referral items 802. The list 802 may be the result of a search using the search control 702, a selection of a referral item category, or referral item recommendations based on other information, such as referral items relevant to content presented at the publisher 106 or referral items having successful referral units. The list 802 can include names of the advertisers 102, a name of the referral item (“product”), a number of associated referral units (“creatives”), a conversion type (e.g., purchase, download, and signup), a conversion value (cost per action), and a referral item performance. In the implementations shown, the performance of a referral item indicates an effective cost of one thousand impressions (eCPM) of the associated referral units. That is, the amount of money generated by presenting the associated referral units to the end users 108 one thousand times. The performance may be estimated by multiplying the cost per action (CPA) with the average conversion rate for that action multiplied by one thousand. Thus, the eCPM is given by

eCPM=CPA*conversion_rate*1000. (1)

Referral item selection controls 804 allow the publisher user to select one or more referral items to include on the publisher website. Other performance indicators are possible.

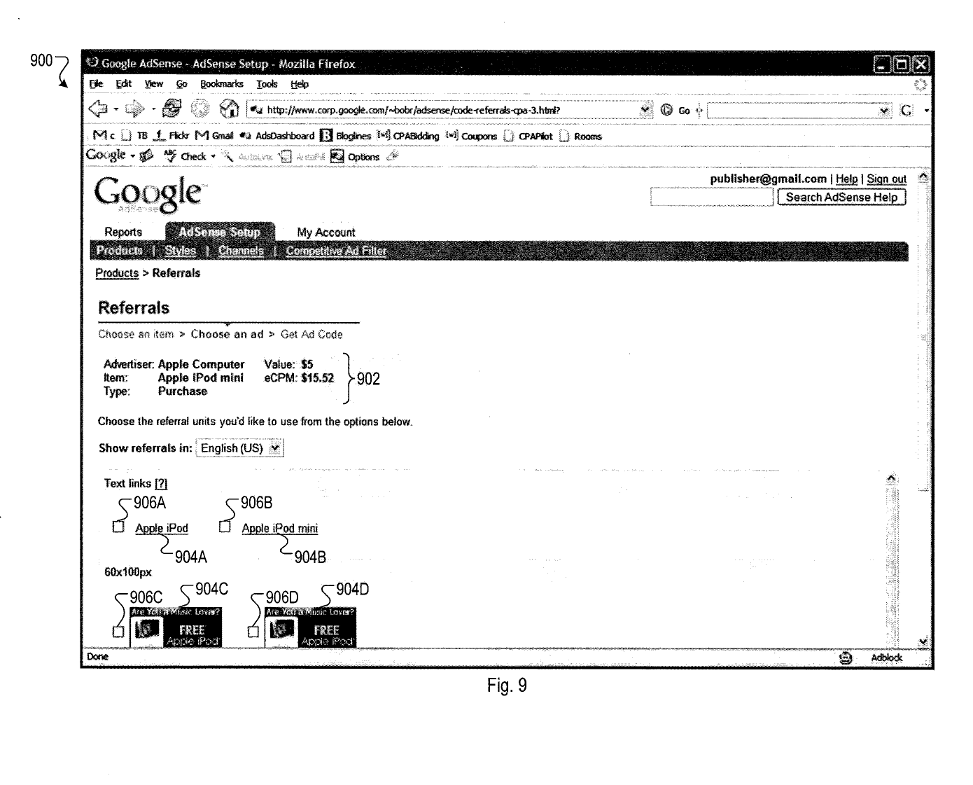

FIG. 9 is an example of a user interface 900 for selecting referral units associated with a referral item. The interface 900 contains information 902 associated with the referral item including the advertiser name, the item name, the conversion type, the conversion value, and the eCPM. Each referral item may have one or more associated referral units, such as text links or images. The interface 900 includes presentations 904A-D of the referral units associated with the selected referral item. Each of the presentations 904A-D has an associated referral unit selection control 906A-D, respectively. The publisher user may select one or more of the selection controls 906A-D and initiate a generation of code snippets associated with the selected referral units.

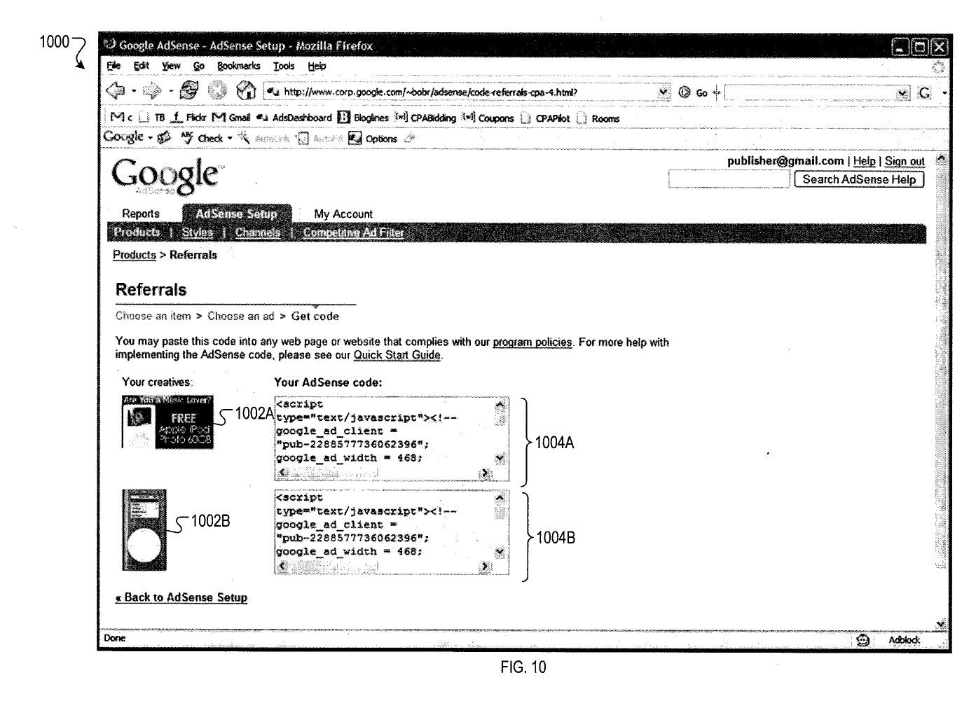

FIG. 10 is an example of a user interface 1000 for presenting code snippets, associated with referral units, to be presented by a publisher system. The interface 1000 includes presentations 1002A-B of the referral units previously selected in the interface 800. Each of the presentations 1002A-B has an associated code snippet 1004A-B, respectively. The system 104 generates the code snippets 1004A-B. In this example, the code snippets 1004A-B are JavaScripts to be included in a web page presented to the end users 108 by one or more of the publishers 106. The code snippets 1004A-B identify the particular referral unit to be presented by a publisher.

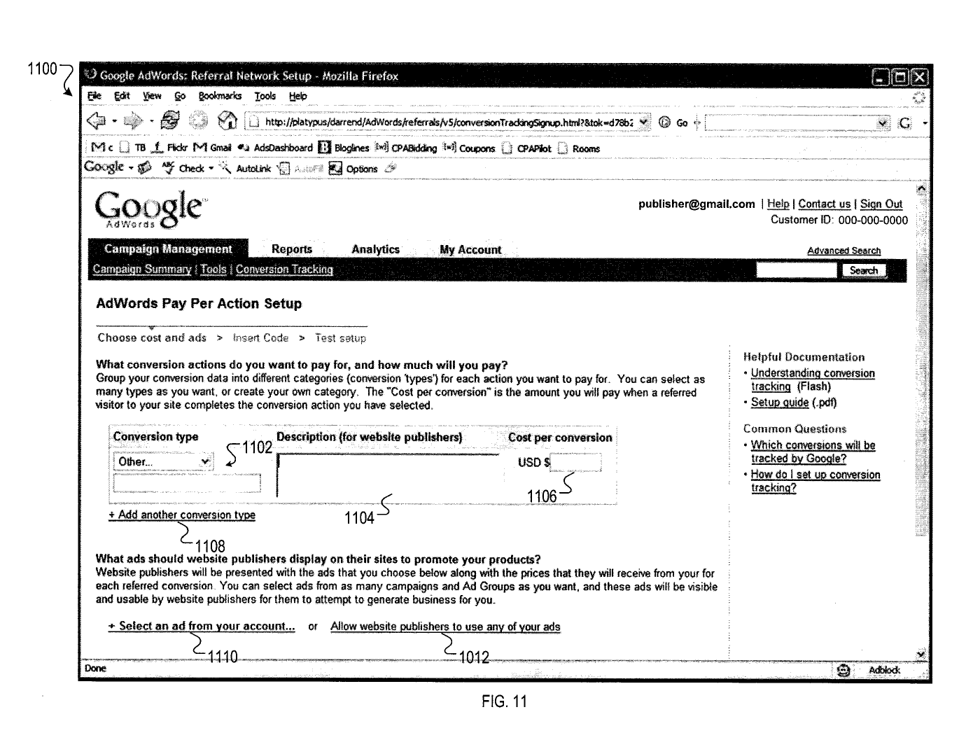

FIG. 11 is an example of a user interface 1100 for creating a referral unit. An advertiser user may use the interface 1100 to create a referral unit. The interface 1100 includes a conversion type selection control 1102, a referral unit description input control 1104, and a cost per conversion input control 1106. The advertiser user may input a conversion type, a description, and a conversion value using the controls 1102, 1104, and 1106, respectively. The interface 1100 also includes a link 1108 to an interface where new conversion types may be added. In addition, the interface 1100 includes links 1110 and 1112 to interfaces where images, audio, text, video, or other media may be associated with the referral unit. In some implementations, the conversion value can be specified as a percentage of the transaction value of the conversion. For example, if the conversion type is “purchase” then the conversion value can be specified as x % (e.g., 1%) of the profit received by the advertiser.

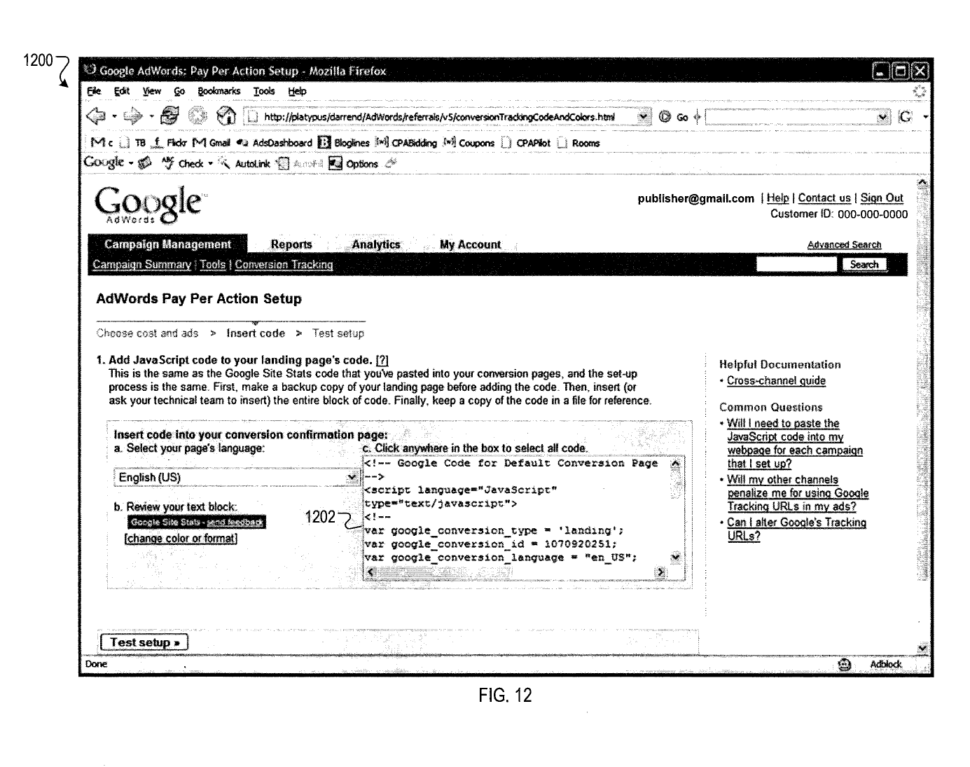

FIG. 12 is an example of a user interface 1200 for presenting a code snippet, associated with a referral unit, to be used at an advertiser system. The interface 1200 presents a code snippet 1202 associated with the created referral unit. The advertiser 102 includes the code snippet 1202 within a conversion confirmation web page. The conversion confirmation web page may be the result of an end user selecting the referral unit on a publisher web page, being directed to an advertiser web page, and performing a conversion action associated with the referral unit.

FIG. 13 is an example of a user interface 1300 for presenting a conversion action report to an advertiser user. The interface 1300 includes a list 1302 of conversion types and a list 1304 of referral units. Each conversion type in the list 1302 contains a conversion type name (“Pay-Per-Action Conversion Types”), a cost per conversion, a total number of conversions, and a total cost of the conversions. The advertiser user may make an input indicating a particular time interval in which to calculate the totals using a time interval selection control 1306. Each of the referral units in the list 1304 contains a referral unit description (“Variations”), a link to edit the conversion actions associated with the referral unit, a status of the referral unit, an average cost per conversion, a total number of conversions, and a total cost of the conversions. The referral unit description further includes a type of the ad (e.g., inline ad or banner ad), a size of the ad, and a depiction of the ad. The advertiser user may monitor the progress of referral units and conversion types using the interface 1300.

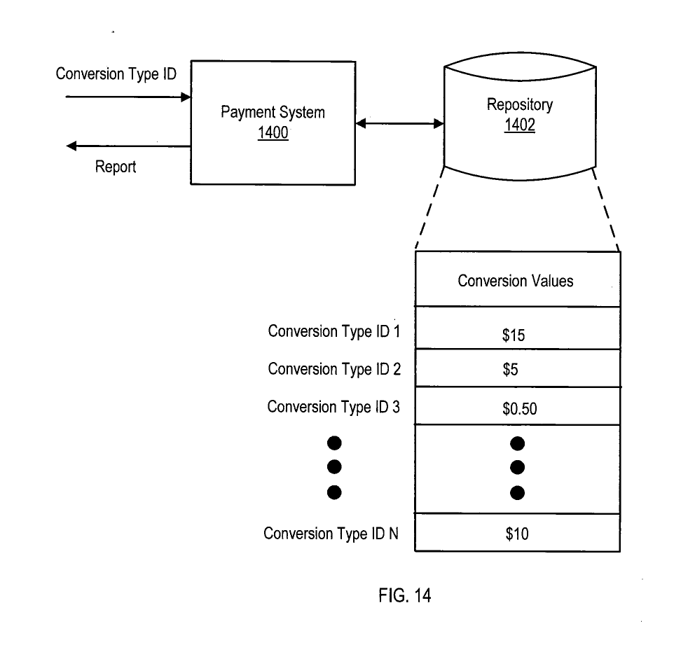

FIG. 14 is a block diagram of an example of a system for storing and retrieving conversion values. The system includes a payment system 1400. The payment system 1400 stores conversion values in a repository 1402. Each conversion value is associated with a particular conversion type identifier. For example, conversion type ID 1 is associated with a conversion value of $15. The payment system 1400 receives a conversion type identifier, such as described above in the process 500. The payment system 1400 retrieves the conversion value associated with the received conversion type identifier from the repository 1402. The payment system 1400 compiles a report of received conversion types and transmits the report to an advertiser system or a publisher system.

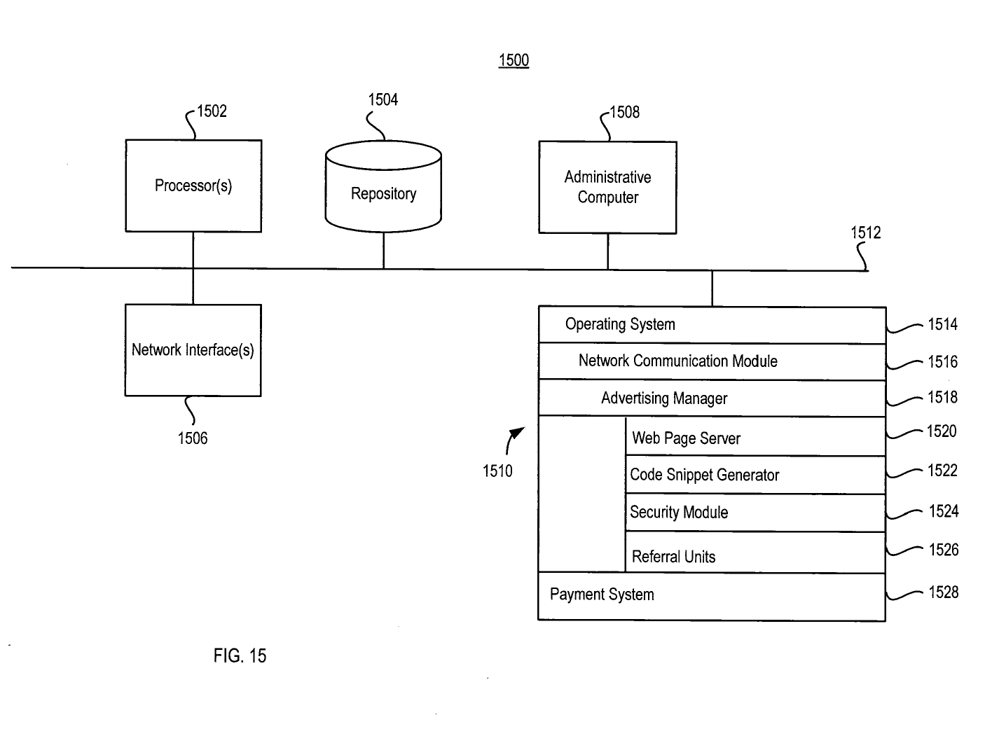

FIG. 15 is a block diagram of example architecture 1500 for an advertising system manager/payment system. Other architectures are possible.

In some implementations, the architecture 1400 includes one or more processors 1502 (e.g., dual-core Intel® Xeon® Processors), one or more repositories 1504, one or more network interfaces 1506, an optional administrative computer 1508 and one or more computer-readable mediums 1510 (e.g., RAM, ROM, SDRAM, hard disk, optical disk, flash memory, etc.). These components can exchange communications and data over one or more communication channels 1512 (e.g., Ethernet) which can include various known network devices (e.g., routers, hubs, gateways, buses) and software (e.g., middleware) for facilitating the transfer of data and control signals between devices.

The term “computer-readable medium” refers to any medium that participates in providing instructions to a processor 1502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 1510 further includes an operating system 1514 (e.g., Linux server, Mac OS® server, Windows® NT server), a network communication module 1516, an advertising system manager 1518 and a payment system 1528.

The operating system 1514 can be multi-user, multiprocessing, multitasking, multithreading, real-time and the like. The operating system 1514 performs basic tasks, including but not limited to: recognizing input from and providing output to the administrator computer 1508; keeping track of files and directories on computer-readable mediums 1510 (e.g., memory or a storage device); controlling peripheral devices (e.g., repository 1504); and managing traffic on the one or more communication channels 1512. The network communications module 1516 includes various components for establishing and maintaining network connections (e.g., software for implementing communication protocols, such as TCP/IP, HTTP, Ethernet, etc.).

The advertising system manager 1518 includes a web page server 1520, a code snippet generator 1522, a security module 1524 and referral units 1526. The web page server 1520 (e.g., Apache web page server) can serve web pages to advertisers and publishers and can provide an input means for advertiser and publisher input into the advertising system manager, as described in reference to FIGS. 7-13. The code snippet generator 1522 can generate the code snippets that are provided to advertisers and publishers, as described in reference to FIGS. 10 and 12. The security module 1524 can be used to digitally sign conversion type identifiers and cookies using known digital signature methods (e.g., RSA, DSA), as described in reference to FIG. 4. Referral units 1526 include image ads, text links, creatives and any other ad that can be placed on a publisher web page to drive users to advertisers.

The payment system 1528 is responsible for implementing the payment process, as described in reference to FIG. 6. The payment process can be fully or partially automated, and can include human intervention at one or more points in the payment process.

Systems and methods disclosed herein may use data signals conveyed using networks (e.g., local area network, wide area network, internet, etc.), fiber optic medium, carrier waves, wireless networks, etc. for communication with one or more data processing devices (e.g., advertisers 102, advertising system manager 104, publishers 106, users 108, advertisement creation system 112, etc.). The data signals can carry any or all of the data disclosed herein that is provided to or from a device.

The methods and systems described herein may be implemented on many different types of processing devices by program code comprising program instructions that are executable by one or more processors. The software program instructions may include source code, object code, machine code, or any other stored data that is operable to cause a processing system to perform methods described herein.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that software instructions or a module can be implemented for example as a subroutine unit of code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

1. A system, comprising:
an advertisement creation engine operable to provide an advertisement creation environment, the advertisement creation environment enabling selection of one or more content items and one or more creative items, the advertisement creation engine being operable to receive instructions associated with the one or more content items and one or more creative items and to generate an advertisement based on the instructions; and
a distribution engine operable to store the advertisement and to serve the advertisement to a community;
wherein the one or more content items comprise user generated content supplied by a remote user.

2. The system of claim 1, further comprising a statistics engine operable to collect statistics associated with the distribution engine serving the advertisement.

3. The system of claim 2, further comprising an account adjustment engine operable to adjust an account associated with an advertisement based upon the collected statistics.

4. The system of claim 3, wherein the account adjustment engine is operable to adjust an account based on a conversion parameter associated with the advertisement.

5. The system of claim 4, wherein the account adjustment engine is further operable to adjust an account based on a cost per action, cost per impression or cost per click billing parameter derived from the advertisement.

6. The system of claim 3, wherein the account adjustment engine is further operable to adjust an advertiser account, a publisher account and a user account associated with the advertisement and based upon the collected statistics.

7. The system of claim 1, further comprising a creative item data store, and wherein the advertisement creation engine is configured access the creative item data store to access the creative items.

8. The system of claim 1, further comprising a content item data store, and wherein the advertisement creation engine is configured to access the content item data store to access the content items.

9. The system of claim 8, wherein the one or more content items comprise public domain content retrieved from a network.

10. The system of claim 8, wherein the one or more content items comprise licensed content retrieved from a network.

11. The system of claim 1, wherein the advertisement creation engine is operable to derive a ratio between selected creative items and content items, and wherein the distribution engine is operable to store the advertisement and the distribution engine is operable to serve the advertisement based upon a comparison between the ratio and a specified ratio, wherein an advertiser requires that an advertisement include a specified ratio between creative items and content items.

12. The system of claim 1, wherein the advertisement creation engine comprises a toolbar interface.

13. A method comprising:
identifying one or more content items and one or more creative items;
receiving instructions associated with one or more content items and one or more creative items;
creating and storing an advertisement based upon the received instructions; and
distributing the advertisement to publishers.

14. The method of claim 13, wherein distributing the advertisement comprises syndicating the advertisement.

15. A method, comprising:
receiving a first selection for a content item from a user;
receiving a second selection for a creative item from the user;
identifying a user-defined advertisement based upon the first and second selections; and
distributing the user-defined advertisement based on the identification;
wherein the content item comprises user generated content supplied by a remote user.

16. The method of claim 15, further comprising receiving the content item from the user.

17. The method of claim 16, wherein identifying a user-defined advertisement based on the first and second selections comprises associating the content item of the first selection with the creative item of the second selection.

18. The method of claim 16, further comprising:
receiving communications associated with the advertisement; and
adjusting one or more accounts based on communications received associated with the advertisement.

19. The method of claim 16, further comprising receiving account information from the user; and adjusting one or more accounts associated with the account information based upon conversions associated with the advertisement.

20. Computer readable media storing instructions that are executable by a processing device, and upon such execution cause the processing device to perform operations comprising receiving a first selection for a content item from a user;
receiving a second selection for a creative item from the user;
identifying a user-defined advertisement based upon the first and second selections; and
distributing the user-defined advertisement based on the identification;
wherein the content item comprises user generated content supplied by a remote user.
